(19) United States
(12) Patent Application Publication
(10) Pub. No.: US 2011/0192868 A1
(43) Pub. Date: Aug. 11, 2011

(54) AIR INGRESS TUBE ASSEMBLY FOR A CONTAINER AND A KIT EMPLOYING SAME

(76) Inventor: John Michael Kardos, Chilliwack (CA)

(21) Appl. No.: 13/023,546

(22) Filed: Feb. 9, 2011

Related U.S. Application Data
(60) Provisional application No. 61/303,311, filed on Feb. 11, 2010.

(51) Int. Cl. B67D 3/00; B65D 25/40; B65D 51/16

(52) U.S. Cl. 222/481.5; 222/567

(57) ABSTRACT

A container, such as a flask, from which a liquid can be poured uninterruptedly employs an air ingress tube which includes a tube attached near one end within the neck of the flask or other container. The tube extends from the neck region of the flask down to near the bottom internal surface of the flask. The tube allows air to flow to the air cavity that is formed when pouring from the flask, resulting in a smooth pour. In addition to the air ingress tube and the flask, a kit may include a specially designed funnel to adjust the tube.

This patent application claims the benefit of U.S. provisional application No. 61/303,311 filed Feb. 11, 2010. The disclosure of the provisional application is hereby incorporated herein by reference.

### TECHNICAL FIELD

This application relates to flasks, and more specifically to an apparatus for smoothing the flow of liquid out of flasks, particularly those with narrow openings.

### BACKGROUND

Flasks or containers have long been known and widely used. One type of flask is sometimes referred to as a “hip flask” as it is narrow and has a slight curve allowing the flask to be carried in a pocket more comfortably than other flasks. Flasks may be used to carry small amounts of liquor. A typical hip flask has a small opening for the contents to be poured from and drunk from. The opening may be sealed by a screw cap to prevent any contents from spilling when not in use. Though such flasks have achieved considerable popularity and commercial success, there is a need for a more efficient pour as the flask opening is narrow. When a traditional flask is tilted to dispense the liquid contents, the necessary flow of air into the flask is constricted by the flow of liquid out of the flask, resulting in a turbulent flow of liquid from the flask such as a gurgling effect, rather than a laminar flow. No known effective and aesthetically pleasing solution has until now been brought to commercial market.

### SUMMARY OF INVENTION

An air ingress tube is attached within the neck of a flask or other container. The tube extends from the neck region of the flask down to near the internal base surface. The tube allows air to flow to the air cavity that is formed when pouring from the flask. When liquid is poured or drunk from the flask, air enters the ingress tube near the flask neck, passes through it and then out into the lower portion of the flask to replace the space vacated by the exiting liquid, resulting in a smooth and uninterrupted pour.

Disclosed herein is a container from which a liquid can be poured uninterruptedly, comprising a body adapted to contain a liquid, a neck on the body having an opening through which liquid may pass into or from the body; an interior base surface on the body; and a hollow conduit disposed in the body and having a first open end mounted inside the neck and a second open end terminating proximal to the interior base surface; wherein, when the body is tilted for pouring out the liquid, an ingress of air through the hollow conduit permits the liquid to pour out uninterruptedly through the neck.

Also disclosed herein is an air ingress tube assembly for a container comprising: a hollow conduit having a first open end and a second open end; a sprung leaf attached to the hollow conduit proximal to the first open end; and a projection at the second open end configured to prevent an interior surface of a container from blocking the second open end.

Further disclosed herein is a kit comprising: an air ingress tube assembly as described above; a hip-flask having a neck; and a funnel, wherein the funnel is configured to be inserted into the neck and mate with the first open end of the hollow conduit.

### BRIEF DESCRIPTION OF DRAWINGS

The drawings illustrate embodiments of the invention, but should not be construed as restricting the scope of the invention in any way.

FIG. 1 is a side view of a container, such as a flask, with an air ingress tube attached to its interior at the neck.

FIG. 2 shows an inverted flask with an air ingress tube.

FIG. 3 shows an air ingress tube mounted in the neck of a flask.

FIG. 4 shows a plan view of an air ingress tube assembly.

FIG. 5 shows an end view of the air ingress tube assembly of FIG. 4.

FIG. 6 shows an isometric view of the inner end of an air ingress tube with a protrusion.

FIGS. 7-8 show a funnel for use with a flask fitted with an air ingress tube assembly.

FIG. 9 shows how a funnel mates with a flask neck and air ingress tube.

FIGS. 10-12 show an alternate way of making an air ingress tube assembly.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

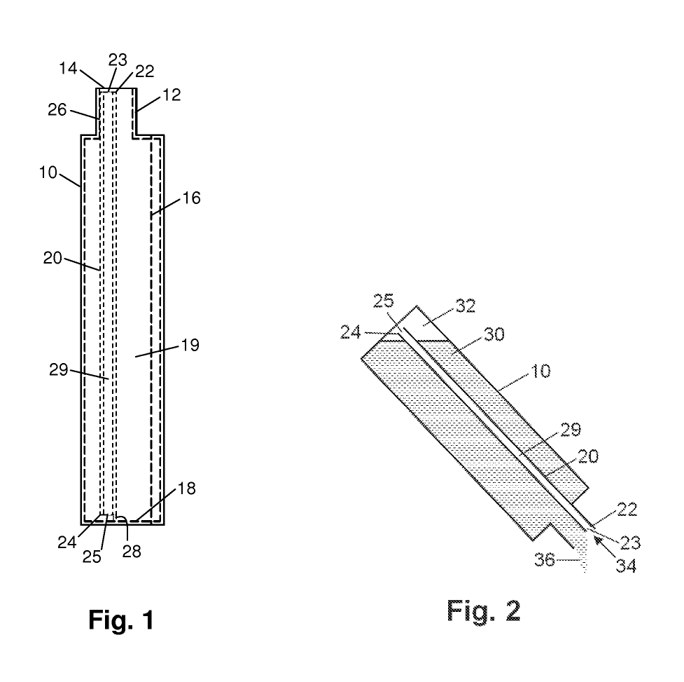

FIG. 1 shows the main elements of an embodiment of the invention. A container such as a hip flask is shown, with a body 10 adapted to contain a liquid, and a neck 12 on the body 10 having an opening or aperture 14 at the upper end of the neck 12 through which the liquid may pass from the body 10. The dotted line 16 indicates the extent of the outer concave surface of the hip flask intended to face the hip when in a pocket. The body 10 of the flask has a lower, interior surface 18 and encloses a volume 19 into which liquids may be poured. Hip flasks with 4 oz, 6 oz, 8 oz or other capacities may be used. Other containers or flasks may be used, and they may be those available off the shelf, e.g. prefabricated, or they may be custom made to accommodate the present invention.

Inside the body 10 of the flask is a tube 20 or other hollow conduit with an outer end 22 having an outer aperture 23, and an inner end 24 having aperture 25. The tube 20 is held in place in the neck 12 on the body 10. In this embodiment, the tube 20 is attached to the inner wall 26 of the neck 12. The attachment of the tube 20 to the inner wall of the neck may be temporary, for example by friction, or permanent, for example by welding. The tube 20 my be attached directly or indirectly, such as via an intermediate component, to the inner wall 26 of the neck 12.

At the inner end 24 of the tube 20 there is a projection 28 which serves to space the inner end 24 of the tube 20 a small distance from the lower interior surface 18 of the body 10. The projection 28 may be in contact with the lower interior surface 18 of the body 10. The projection 28 may be formed by cutting away a portion of the tube rim. The projection 28 is optional. In the case where a tube 20 is accurately welded to the inner surface of the neck, there may be no need for a projection 28. If the tube 20 is held in the neck by friction, there may be some freedom for it to move up and down, and so a projection 28 may be necessary. The function of the projection is to prevent the aperture 25 of the inner end 24 of the tube 20 from being substantially closed by the lower interior surface 18 of the body 10. Other forms of projection may be employed, or other forms of aperture may be used in order to provide this function, such as an aperture in the side wall of the tube.

Note that the outer end 22 of the tube 20 sits a little way below the aperture 14 of the flask. This is not a requirement, but it makes the flask more comfortable to drink from.

In operation one uses the flask in a normal manner by filling the flask with a liquid of choice through the top opening 14 of the flask. The user can dispense the liquid by simply tilting the flask to the desired degree.

FIG. 2 shows the operation of an air ingress tube 20. When the body 10 of the flask is tilted, liquid 30 within the flask settles as shown to leave an air pocket 32 above it. Air from outside the flask is free to flow 34 into the opening aperture 23 of the outer end 22 of the tube 20, through the interior cavity 29 of the tube 20, out of the inner aperture 25 at the inner end 24 of the tube and into the air pocket 32. Since air 34 can flow freely into the flask, liquid 36 can flow freely from the flask. Advantageously, the flow of liquid 36 out of the flask is not interrupted by a flow of air into the flask though the same orifice, resulting in a smooth, uninterrupted flow of liquid and no gurgling effect.

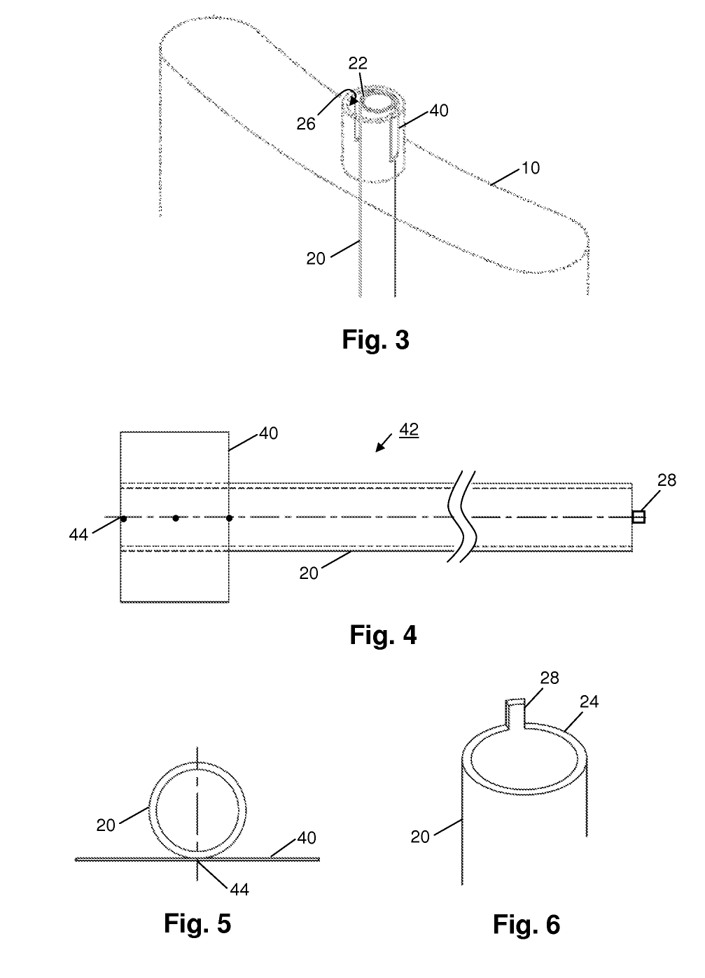

FIG. 3 shows an isometric view of the preferred embodiment of the air ingress tube 20 in position in the body 10 of the flask. Attached to the outer end 22 of the tube 20 is a securing piece 40 that has been cut in a fashion to hold the tube in place within the neck of the flask. The securing piece 40 is a thin piece of springy material, or sprung leaf. The securing piece 40 naturally springs outwards, pressing against the inner surface 26 of the neck of the flask. The tube assembly may be removed and replaced by hand, or with the aid of small pliers, to aid in cleaning of the flask and the tube. Depending on the amount of friction generated, the flask may be shaken vigorously without the tube assembly falling out. The air ingress tube assembly does not hinder the filling of the flask in any significant way.

FIG. 4 shows a top view of the air ingress tube assembly 42. The securing piece 40 is attached to the tube 20 with one or more laser welds 44. These may be laser spot welds, for example. Other means of attachment of the tube 20 to the securing piece 40 may be used, such as adhesive. Note that the securing piece 40 is attached to the opposite side of the tube 20 to the projection 28. Here, the projection 28 is at the bottom of the tube 20 as drawn, and the securing piece 40 is over the tube 20. This ensures optimum positioning of the projection when the tube is in its optimum position. The optimum position of the projection is as close as possible to the center of the interior base of the flask, leaving the inner end of the tube open nearer to the edge of the flask, where the air cavity is more likely to be when the flask is tilted for pouring.

FIG. 5 shows an end view of the air ingress tube assembly 42, showing the tube 20 and the securing piece 40. In this view, the flexible, securing piece 40 is shown flat. In practice, it may be curved in its natural state, and it may be imparted with such curvature either before or after attachment to the tube 20. Hand rolling or automated means may be used to provide the curvature.

FIG. 6 shows a closer view of the inner end 24 of the tube 20, showing the spacing projection 28. The projection 28 is formed as a one-piece component with the tube 20, but other forms are possible, including clip-on pieces that are made separately from the tube and attach thereto. The height of the projection 28 should be as small as possible while still allowing for adequate airflow into the flask. As an example only, height and width of the projection may each be 1.5 mm, but other sizes and different sizes for each are possible, as well as different shapes.

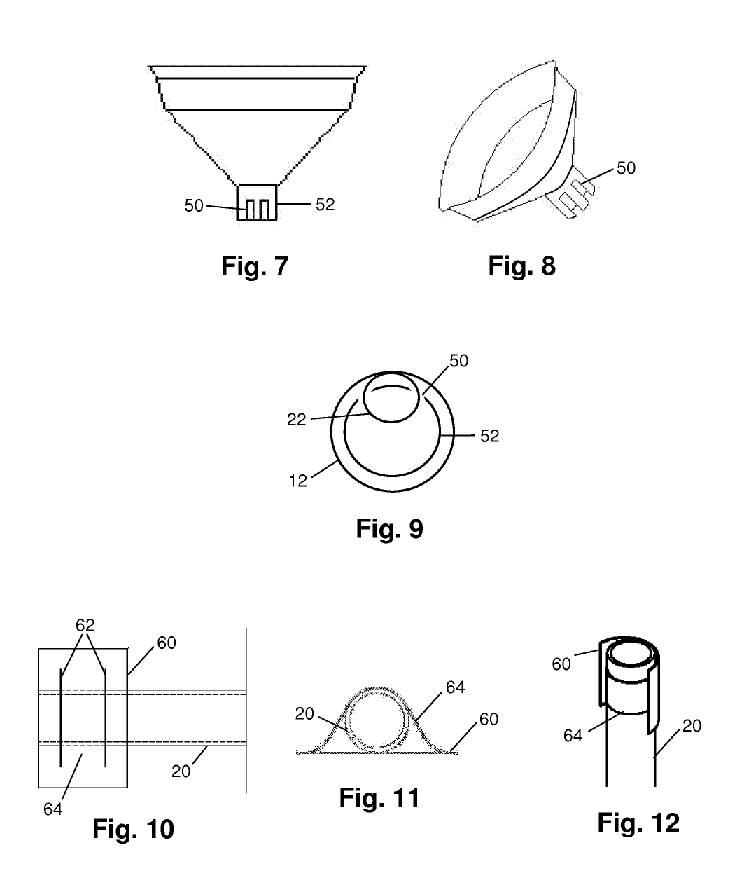

FIG. 7 shows a funnel that may be used in conjunction with the air ingress tube assembly 42. Funnels are sometimes provided with hip flasks in order to help fill them with liquor. The funnel shown here has two slots 50 in its neck 52. FIG. 8 shows a different view of the funnel. FIG. 9 shows how the neck 52 of the funnel mates with the outer end 22 of the air ingress tube 20 and the neck 12 of the flask. The slots 50 in the neck 52 of the funnel pass over the outer end 22 of the tube 20.

A secondary function of the funnel is to assist in alignment of the air ingress tube assembly 42, in cases where it is held in place by friction. Optimally, when pouring liquid out, the tube 20 should be in the uppermost position possible within the neck 12 of the flask. This allows the liquid to flow out though what becomes the lower portion of the neck aperture, and air to enter above it, through the air ingress tube. Where the air ingress tube assembly 42 is held in place by friction, it may become angularly displaced relative to its optimum position, or it may be not quite aligned after it has been removed for cleaning. By mating the funnel to the tube assembly, it is possible to rotate the air ingress tube assembly 42 by rotating the funnel.

The funnel may be provided with a hip flask fitted with an air ingress tube assembly. Alternately, the funnel may be provided with an air ingress assembly and a hip flask as a kit of three parts, for the purchaser to assemble.

FIG. 10 shows an alternate way of making an air ingress tube assembly. In this embodiment, the securing piece 60 has two parallel slits 62 between which is a central area 64. The central area 64 is pulled upwards, allowing the tube 20 to fit below the central area 64 and above the remainder of the thin piece 60, as shown in FIG. 11 and FIG. 12.

Examples of materials used include stainless steel for the body 10 and neck 12 of the flask, tube 20 and securing piece 40. The securing piece may be made from 3 thou thickness stainless steel 304, for example, or other types of shim metal. Metals used may be medical grade, for example. The tubing may be thin walled hypodermic tubing, for example, with outer diameter 0.246″ and inner diameter 0.21″. The tubing and/or container and/or securing piece may be plastic, and each may have some flexibility.

The reader will see that the embodiments of the flask with an air ingress tube assembly as shown herein provide an uninterrupted flow of liquid out of the flask and an uninterrupted flow of air into the tube. The flask with air ingress tube assembly results in a significantly increased rate of flow from the flask compared to the rate of flow from the flask alone. The user of the flask will not only be able to drink or pour more quickly but will also have the benefit of a smooth and laminar pour rather than a turbulent flow. While the above description contains many specificities, these should not be construed as limitations on the scope, but rather as an exemplification of preferred embodiments thereof.

As will be apparent to those skilled in the art in the light of the foregoing disclosure, many alterations and modifications are possible in the practice of this invention without departing from the scope thereof. Thus the flask may be replaced with any container of any material with a narrow opening, tube 20 may be replaced by any hollow path of any material and length and the tube or hollow path may be secured into the container by any means. The results will be the same. Depending on the intended uses, i.e. size of container, size of neck, viscosity, density and temperature of liquid to be used, materials to be used, surface tensions, etc. then different dimensions may need to be employed for the air ingress tubes for each different liquid, even though containers and necks are nominally the same size.

Furthermore, while the tubes or hollow conduits have been shown herein to have a circular cross-section, tubes with other cross-sectional shapes are possible, such as elliptical, square, rectangular, triangular, etc. Tubes need not be straight. The tube may be replaced with any hollow conduit extending from near the entrance of the container to the base of the container.

Accordingly, the scope of the invention is to be construed in accordance with the substance defined by the following claims.

1. A container from which a liquid can be poured uninterruptedly, comprising a body adapted to contain a liquid;
a neck on the body having an opening through which liquid may pass from the body;
an interior base surface on the body; and
a hollow conduit disposed in the body and having a first open end mounted inside the neck and a second open end terminating proximal to the interior base surface;
wherein, when the body is tilted for pouring out the liquid, an ingress of air through the hollow conduit permits the liquid to pour out uninterruptedly through the neck.

2. The container of claim 1 wherein the first open end is permanently mounted inside the neck.

3. The container of claim 1 wherein the first open end is removably mounted in the neck.

4. The container of claim 3 further comprising a projection at the second open end of the hollow conduit that contacts the interior base surface to prevent blockage of the second open end by the interior base surface.

5. The container of claim 4 wherein the projection is located adjacent to the center of the interior base surface.

6. The container of claim 3 further comprising a sprung leaf permanently attached to the hollow conduit proximal to the first open end, wherein the leaf presses outwards against an interior surface of the neck.

7. The container of claim 6 wherein the sprung leaf is laser spot welded to the hollow conduit.

8. The container of claim 6 wherein the leaf presses outwards with sufficient force to prevent the hollow conduit from falling out of the container when the container is inverted.

9. The container of claim 1 wherein the hollow conduit is a tube.

10. The container of claim 1 wherein the first open end is mounted below the opening in the neck.

11. An air ingress tube assembly for a container, comprising:
a hollow conduit having a first open end and a second open end;
a sprung leaf attached to the hollow conduit proximal to the first open end; and
a projection at the second open end configured to prevent an interior surface of a container from blocking the second open end.

12. The assembly of claim 11 wherein the sprung leaf is removably attached to the hollow conduit.

13. The assembly of claim 11 wherein the sprung leaf is laser spot welded to the hollow conduit.

14. The assembly of claim 11 wherein the sprung leaf and the hollow conduit are made from stainless steel.

15. The assembly of claim 11 wherein the hollow conduit is a tube.

16. A kit, comprising:
an air ingress tube assembly including
a hollow conduit having a first open end and a second open end;
a sprung leaf attached to the hollow conduit proximal to the first open end; and
a projection at the second open end configured to prevent an interior surface of a container from blocking the second open end;
a hip-flask having a neck, the hollow conduit being insertable in the hip-flask with the sprung leaf supporting the first open end of the hollow conduit in the neck of the hip-flask; and
a funnel,
wherein the funnel is configured to be inserted into the neck and mate with the first open end of the hollow conduit.

17. The kit according to claim 16 wherein the funnel is configured to rotate the assembly when the assembly is mounted inside the neck.
